(19) United States
(12) Patent Application Publication
(10) Pub. No.: US 2009/0119287 A1
(43) Pub. Date: May 7, 2009

(54) IMAGE PROCESSING APPARATUS, INFORMATION PROCESSING METHOD, AND COMPUTER-READABLE STORAGE MEDIUM

(75) Inventor: JUNJI SATO, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/262,512

(22) Filed: Oct. 31, 2008

(30) Foreign Application Priority Data
Nov. 6, 2007 (JP) 2007-288740

(51) Int. Cl. G06F 7/06; G06F 17/30

(52) U.S. Cl. 707/5; 707/E17.014

(57) ABSTRACT

The Object of the present invention is providing a filtering function that is easily used for filtering a document whose importance is changed as time passes. For that end, importance of each search condition and a valid period of the importance are set in association with each other. On searching log data matching the set search condition, calculation is performed on a score of log data matching the search condition on the basis of an execution time of a search, importance of the search condition and the valid period of the importance. Log data having the score thus calculated exceeding a predetermined threshold is extracted.

### BACKGROUND OF THE INVENTION

1. Field of the Invention

The present invention relates to a technique of auditing job records capable of storing log data of a job executed by an information processing apparatus (particularly, by an image processing apparatus) so as to prevent an information leak by tracking back the log data after the executing of the job.

2. Description of the Related Art

With the development of computer techniques and the spread of digital multifunction devices, operations such as printing, copying, and transmission of a document have been facilitated recently. The improved convenience however has increased the risk of information leak due to the printing and copying of confidential document. Accordingly, information management in business activity has been of significant concern. To prevent such information leak, a job record audit system is provided in which execution information logs of jobs (print, copy, facsimile transmission/reception and the like) executed by a printer, a digital multifunction device and the like is stored in a storage device as log (record) data. When information is leaked in the foregoing system, the stored job log data can be referenced to track back the record as to when, where and how information is processed. Accordingly, such a system is expected to prevent illegal job execution as well as information leaks.

In the foregoing system, generally, a filtering technique is used, which automatically searches for illegal job log data in order to efficiently extract and audit illegal job log data among a large amount of stored job log data. Filtering mentioned here is a method to set search conditions in advance to perform search processing to extract hit data under the set search conditions, with a predetermined timing. Such a method for carrying out filtering on the basis of a keyword is described in Japanese Patent Laid-Open Nos. 2001-175675 and H08-161348.

In Japanese Patent Laid-Open No. 2001-175675, multiple keywords and a logical operator that logically combines the multiple keywords are inputted as search conditions, data is scored on the basis of the inputted search conditions, and then it is determined whether or not to extract the data as a result of filtering from the total of scores of the data.

In Japanese Patent Laid-Open No. H08-161348, filtering is performed on a document based on age (newness) of the document in addition to a keyword. In other words, a document is filtered by regarding the age of the document, i.e., newly created or newly received, as the more important consideration.

On the other hand, the importance of the keyword or the image used as search conditions can be changed in some cases as time passes. For example, a new product name to be released is highly important as a internal secret before announcement of the product, however, after announcement of the product, the name would be known to the public, and therefore the importance of the keyword would be reduced.

However, the method disclosed in Japanese Patent Laid-Open No. 2001-175675 can not perform filtering based on the importance of information changing over time. Moreover, as the filtering is based on a keyword, it may not be possible to conduct a sufficient search if a user cannot set an appropriate keyword.

On the other hand, in the method disclosed in Japanese Patent Laid-Open No. H08-161348, filtering is performed according to the age (newness) of the document itself, based on criteria such as date and time when the document is created or received. The method is not based on consideration of a change in importance of the search condition itself, such as the search keyword or the like, as time passes. Furthermore, the methods described in Japanese Patent Laid-Open Nos. 2001-175675 and H08-161348 are not able to perform filtering effectively on job log data in which an image, not a text, is important, such as design material of a new product.

### SUMMARY OF THE INVENTION

The present invention includes the following features.

According to a first aspect of the present invention, there is provided an information processing apparatus that searches for log data. The information processing apparatus comprises, a search condition setting unit configured to set one or more search conditions, an importance setting unit configured to set the importance of each of the search condition and a valid period of the importance in association with the importance, a searching unit configured to search for log data matching the search conditions set by the search condition setting unit, a score calculating unit configured to calculate a score of log data matching the search conditions on the basis of an execution time of the search, the importance of the respective search conditions, and valid periods of the respective importance, and an extracting unit configured to extract log data with a score calculated by the score calculating unit that exceeds a predetermined threshold.

According to a first aspect of the present invention, an information processing method is provided. The method comprises, a search condition setting step of setting one or more search conditions, an importance setting step of setting importance of each of the search condition and a valid period of the importance in association with each other, a searching step of searching for log data matching the search conditions set in the search condition setting step, a score calculating step of calculating a score of log data matching the search conditions on the basis of an execution time of the search, importances of the respective search conditions and valid periods of the respective importances, and an extracting step of extracting log data with a score calculated in the score calculating step exceeding a predetermined threshold.

In the present description, it is assumed that the information processing apparatus (PC, server, or the like) includes a dedicated image processing apparatus, image forming apparatus and the like in addition to a general-purpose information processing apparatus, so that the apparatuses can execute the processes according to the present invention.

The present invention can perform filtering in consideration of the importance of information, by setting the importance and a valid period as search conditions and by dynamically changing a value of the importance according to the valid period.

In addition, the present invention can use a keyword, an image, and attribute information as search conditions, and dynamically change the importance of the information by setting the importance and the valid period. Therefore, this configuration of the present invention enhances the flexibility of filtering and facilitates the use of the information filtering.

Further features of the present invention will become apparent from the following description of exemplary embodiments (with reference to the attached drawings).

### BRIEF DESCRIPTION OF THE DRAWINGS

FIG. 1 is a system configuration diagram according to a first embodiment of the present invention;

FIG. 2 is a block diagram showing a hardware configuration for each of a client PC 101, a data processing server 104, a search client PC 105, a search server 106, and a database server 107 according to the first embodiment of the present invention;

FIG. 3 is a diagram for explanation to show one example of a search condition according to the first embodiment of the present invention;

FIG. 4 is a flowchart showing processing of filtering according to the first embodiment of the present invention;

FIG. 5 is a flowchart showing processing of score calculation according to the first embodiment of the present invention;

FIG. 6 is a flowchart showing processing for creating information list according to the first embodiment of the present invention;

FIG. 7 is a conceptual diagram of job log data according to the first embodiment of the present invention; and

FIG. 8 is a diagram for explanation to show one example of an information list according to the first embodiment of the present invention.

### DESCRIPTION OF THE EMBODIMENTS

### First Embodiment

One embodiment of the present invention will be described below on the basis of the drawings.

### (Outline of System Configuration and Operation)

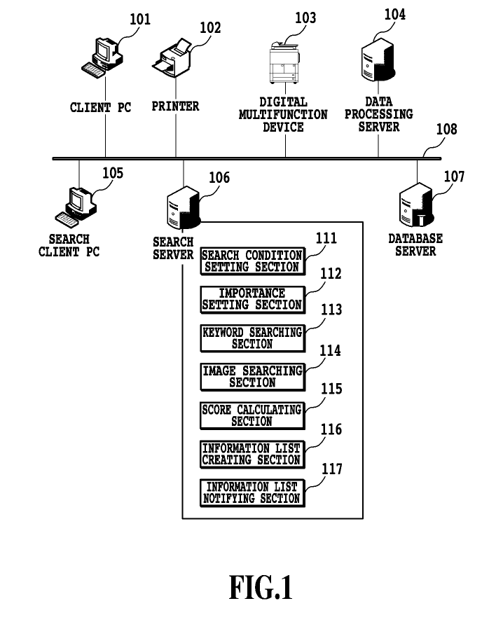

FIG. 1 shows a system configuration of the present embodiment.

As shown in FIG. 1, each of the configuration components is connected to one another via a network 108 such as a LAN or the like.

A client PC 101 generates two types of data according to a print instruction from a user. One type of data is job log data stored as a print execution record. The job log data comprises: job log attribute information including information such as the type of an executed job, start time of a job, setting location of a device; and job log content data including data such as an image and a text of a document processed in preparing the job. The other type of data is print data generated by general print processing. In addition, the job log data is identified by a job log ID.

The client PC 101 transmits job log data to a data processing server 104 and transmits print data to a printer 102 or a digital multifunction device 103 according to a print instruction from a user. The printer 102 and the digital multifunction device 103 execute printing according to the print data received from the client PC 101.

The data processing server 104 performs data processing such as extracting a feature of an image or recognizing by OCR (Optical Character Recognition) job log data received from the client PC 101. Then, the data processing sever 104 transmits to a database server 107 the obtained information as search data in association with job log data. Likewise, job log data generated through input and output jobs such as copying and scanning, executed by the digital multifunction device 103, is transmitted to the data processing server 104. Then, the data processing server 104 associates the search data obtained by the data processing with the job log data to transmit the data to the database server 107.

The database server 107 stores job log data received from the data processing server 104. A search client PC 105 provides filtering settings on the search server 106, such as a search conditions and the importance of the information. The search server 106 makes a search request to the database server 107 on the basis settings of the filtering conditions. The database server 107 performs search processing on the job log data stored on the basis of the search request from the search server 106, and sends a search result back to the search server 106.

The search server 106 calculates a score of each of the job log data on the basis of the importance setting, for the search result obtained from the database server 107. Then, the search server 106 extracts the job log data in which the calculated score is a predetermined threshold or more to create an information list of the score, and notify of the information list to an auditor via e-mail or the like. Details of the processing in the search server 106 will be described later.

In the configuration of the present embodiment, the client PC 101 generates job log data and transmits the data to the data processing server 104. As another configuration, a printer server is provided to generate job log data on the print server according to a print instruction from the client PC 101.

### (Processing in Search Server 106)

Next, the detailed description of processing in the search server 106 is made below referring to FIG. 1.

A search condition setting section 111 and an importance setting section 112 shown in FIG. 1 sets a search condition and importance according to filtering setting(s) inputted from the search client PC 105. A keyword searching section 113 and an image searching section 114 transmit a search request to the database server 107 on the basis of the search condition set by the search condition setting section 111. The search request is periodically transmitted at a predetermined timing set in advance by a user, for example, at midnight everyday.

A score calculating section 115 calculates a score of the job log data respectively for the search results of the keyword searching section 113 and the image searching section 114 on the basis of the importance set by the importance setting section 112. An information list creating section 116 refers to the score of job log data calculated by the score calculating section 115 to extract job log data having the corresponding score exceeding a predetermined threshold to create an information list for the extracted job log data. An information list notifying section 117 notifies an auditor of the information list thus created by the information list creating section 116 via e-mail or the like. The details on processing of the score calculating section 115 and the information list creating section 116 will be described later.

### (Explanation of Hardware Configuration of PC and Server)

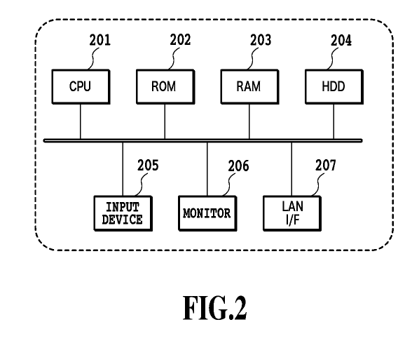

FIG. 2 is a block diagram showing a hardware configuration of the client PC 101, the data processing server 104, the search client PC 105, the search server 106, and the database server 107. A general purpose PC such as an IBM (registered trademark)—PC/AT compatible machine can be used in any of these components and therefore they are shown in the same block diagram. In addition, as long as the function of the present invention can be executed, any configuration may be used such as a configuration of a single device, a configuration of a system including multiple devices, and a configuration of a system in which connection is made via a network such as a LAN to perform processing.

A CPU 201 directly or indirectly controls each of devices (ROM or RAM to be described later, or the like) connected to one another via an internal bus, and executes a program for executing various types of processings in the present embodiment. A ROM 202 stores basic software such as BIOS or the like. A RAM 203 is used as a work space of the CPU 201 or a temporarily storing area for loading the program.

A HDD 204 stores said program as a file. An input device 205 has a function of operating a program having a GUI including an operation screen among the programs. A monitor 206 includes a display function for checking an operation by the input device 205 and an operation of the program. A network interface (LAN I/F) 207 includes a function for connection to a network. An application and service to be run by the present apparatus are stored in the HDD 204, and loaded on the RAM 203 at the time of execution, and executed under control of the CPU 201.

### (Search Condition, Importance, and Valid Period)

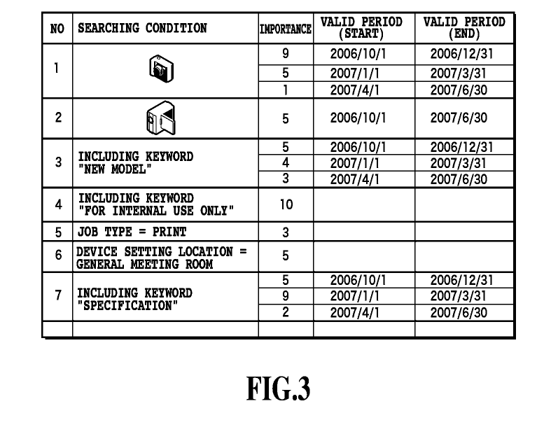

FIG. 3 shows an example of search conditions set by the search condition setting section 111 and the importance setting section 112. The search condition setting section 111 sets an image, a keyword and the aforementioned job log attribute information as search conditions. The importance setting section 112 sets the importance and the valid period of the importance for each of the search conditions set by the search condition setting section 111. The search conditions, the importance and the valid period are instructed by the user via the operation screen.

In an example in FIG. 3, a camera image is registered as a search condition No. 1. To be more specific, importance of the image is set as 9 during a time period from Oct. 1, 2006 to Dec. 31, 2006. The importance is set as 5 during a time period from Jan. 1, 2007 to Mar. 31, 2007, and the importance is set as 1 during a time period from Apr. 1, 2007 to Jun. 30, 2007. As another search condition, the keyword including a “for internal use only” is designated as a search condition No. 4. No valid period is set to the search condition No. 4, since this condition should be kept valid regardless of the time period.

In the present embodiment, as described above, the importance of the search condition can be changed automatically by setting the various types of importance according to the period of time. Accordingly, flexible filtering can be performed in consideration of the importance at the date and time when the job is treated (e.g. filtered, or searched). For example, if a future importance is set in advance according to the schedule of the product development, a change of importance in the time of filtering can be automatically performed such that information before being announced to the public has higher importance and information after being announced has lower importance. In addition, in a case where an announcement is delayed, a valid period of importance is set again to cope with such a case easily. Furthermore, the importance can be increased as time passes or increased only for a predetermined period of time, as shown in the search condition No. 7.

The search condition may be stored on the searching server 106 or may be stored on other server such as the database server 107. Furthermore, it may be possible to set intervals at which filtering is performed and set a score threshold on each of the stored multiple search conditions so that further advanced multiple filtering can be performed.

### (Filtering Processing)

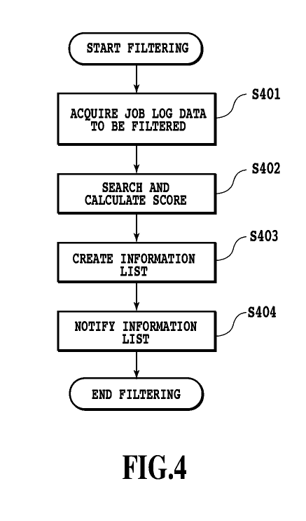

Next, details on filtering processing will be explained referring to FIG. 4.

FIG. 4 is a flowchart showing the flow of filtering processing.

In step S401, job log data as a target for filtering (searching target) is acquired. For example, in a case where filtering is to be performed at a predetermined time (for example, one o'clock in the morning) everyday, a result of processed job log data is stored and the job log data for previous day can be set to be filtered. In this way, filtering may be performed only on difference of job log data.

In step S402, job log data search processing and score calculation processing are performed on a group of job log data targeted for filtering in step S401 on the basis of the search conditions set by the search condition setting section 111. Details will be described later about the processing performed in this step, specifically, the job log data search processing by the keyword searching section 113 and the image searching section 114, and the score calculation processing by the score calculating section 115.

In step S403, as a result of the job log data search processing and the score calculation processing performed in step S402, an information list of job log data having a score exceeding a predetermined threshold is created. Details on the information list creation processing will described later.

In step S404, the information list of job log data created in step S403 is notified to a user. For example, the created information list is sent to a mail address of a user previously registered as a system manager. Moreover, the information list may be stored in the searching server 106 or the database server 107 to notify of the user the location of the information list.

(Job Log Data Search Processing (keyword Searching, Image Searching) and Score Calculation Processing)

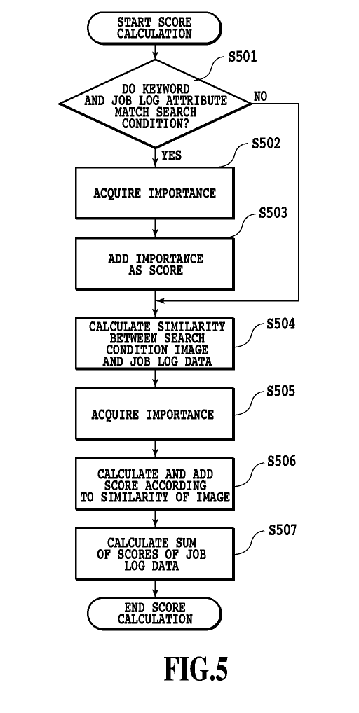

Hereinafter, details on the job log data search processing and score calculation processing will be described referring to FIG. 5.

FIG. 5 is a flowchart showing processing in the keyword searching section 113, the image searching section 114, and the score calculating section 115.

The score calculation processing is performed on each of job log data targeted for filtering (searching target) stored in the database server 107. First of all, in step S501, it is determined whether or not a keyword and a job log attribute set as searching conditions match the job log data to be processed. When they match each other, importance acquisition in step S502 and score addition in step S503 are performed.

In step S502, a currently valid importance is acquired from the valid period associated with the matched search conditions. In an example in FIG. 3, in a case where the filtering execution date (namely, searching execution time) is Jan. 1, 2007 and a keyword “new model” is included in job log data, the importance is 4.

Next, in the score addition in step S503, the importance acquired in step S502 is added as a score of the job log data (note that an initial value of score is assumed to have been initially set). When multiple keywords and job log attributes match search conditions in step S501, a score is added to all of the matched search conditions.

Next, in step S504, the similarity between an image of a search condition and an image included in job log data is calculated. As a method for calculating the similarity, a generally known method may be used, which compare feature amount such as an edge of the image, luminance, or the like, therebetween.

Instep S505, similar to step S502, a currently valid importance is acquired from the valid period associated with the image of the search condition.

Subsequently, in step S506, the image similarity calculated in step S504 and the importance acquired in step S505 are substituted into a predetermined formula so as to calculate a score. For example, when the image similarity is expressed as a percentage from 0 to 100, a score is calculated by multiplying the similarity (Sim) by the importance (Imp) as in the following formula.

Score=Sim×Imp

In this case, when the similarity is high, i.e., close to 100 percent, the score also increases, and when the similarity is low, to be close to 0 percent, the score also decreases. It is of course that the formula for calculating the score is not limited to the above equation. In the present embodiment, it is assumed that a positive value is taken as a score. Therefore, the predetermined formula is employed in which a high value is found when the image similarity is high and a low value is found when the image similarity is low. Additionally, in a case where a negative value is used as a score, an equation is used in which a low value is found when the image similarity is high and a high value is found when the image similarity is low.

Finally, in step S507, a sum of the calculated score of job log data is calculated.

### (Information List Creation Processing)

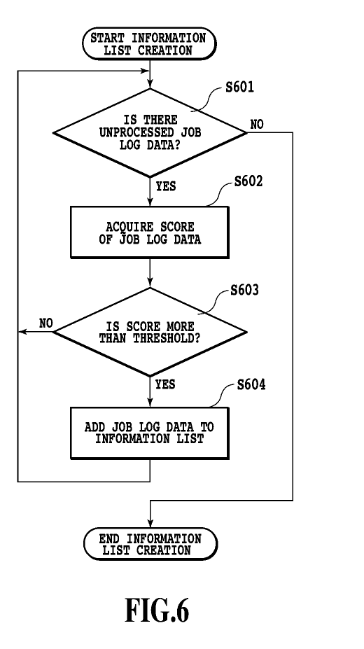

Next, details on information list creation processing will be explained referring to FIG. 6.

FIG. 6 is a flowchart showing processing in the information list creating section 116.

In step S601, it is detected whether or not there is unprocessed job log data in the information list creation processing among the job log data which have completed the search processing and the score calculation processing.

In step S602, a score of the unprocessed job log data extracted in step S601 is acquired. In addition, the score to be acquired is calculated as mentioned above.

In step S603, it is determined whether or not the score of job log data acquired in step S602 exceeds a threshold set in advance (whether or not exceeding a predetermined threshold). In the present embodiment, the positive value is used as a score. However, when a negative value is used as a score, the case where the score of job log data is less than the predetermined threshold means that the score of job log data exceeds the predetermined threshold.

When the score of job log data is the predetermined threshold or more, the job log data is added to the information list as job log data that is hit (satisfy certain conditions) in filtering processing. On the other hand, when the score of job log data falls below the predetermined threshold, the job log data is determined as being unnecessary to be extracted, and processing proceeds to next data of the unprocessed job log data.

The above has explained details on information list creation processing.

As mentioned above, according to the present embodiment, the processing flow focuses on one job log data to calculate a score of the data and repeats the calculation based on the amount of the job log data at the time of calculation the score. However, the processing flow and algorithm in the score calculation are not limited to the above. For example, the processing flow may be that one search condition is focused, all job log data satisfying the condition are extracted, the scores of the data are added at once, the addition is repeated by the number of search conditions to sum up the scores of the respective job log data, and finally job log data exceeding the threshold is extracted.

### (Specific Examples of Score Calculation and Score Determination)

Hereinafter, specific examples on the score calculation of job log data will be described.

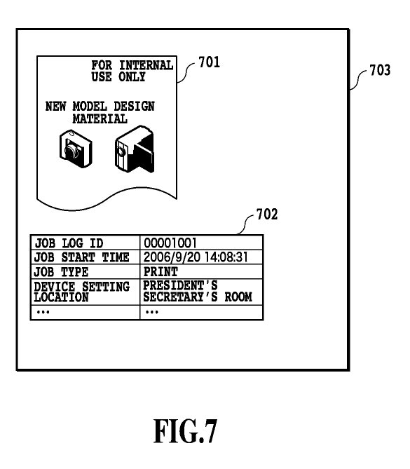

FIG. 7 is a conceptual diagram of job log data.

Job log data 703 comprises job log content data 701 including an image and a text and job log attribute information 702 associated therewith.

The following will explain a case in which a score calculation of job log data 703 is performed on the basis of the search conditions in FIG. 3. To make an explanation easy, the assumption is made that similarity between each of images of search conditions No. 1 and No. 2 in FIG. 3 and an image included in job log content data 701 is 90%. It is also assumed that the score obtained by the image search is calculated using a value obtained with multiplication of the set importance by the similarity obtained by the image search.

Under the aforementioned assumptions, when the filtering execution date is Dec. 1, 2006, the score under the search condition No. 1 is 8.1 since similarity is 90% while importance being 9. Likewise, the score under search condition No. 2 is 4.5 since similarity is 90% while importance being 5. Moreover, job log content data 701 includes a character string of “new model” and that of “for internal use only” in the document, and therefore 5 and 10 are added to the scores under the search conditions No. 3 and No. 4, respectively. Furthermore, since the fact that the job type is print matches the search condition No. 5 in job log attribute information 702, and therefore 3 is added to the score. Thus, the score of job log data 703 is calculated as 30.6.

In the case where the filtering execution date is Jun. 1, 2007, the score under search condition No. 1 is 0.9 since similarity is 90% while importance being 1. Likewise, the score under search condition No. 2 is 4.5 since similarity is 90% while importance being 5. Moreover, job log content data 701 includes a character string of “new model” and “for internal use only” in the document, and therefore 3 and 10 are added to the scores under the search conditions No. 3 and No. 4, respectively. Furthermore, since the fact that the job type is print matches the search condition No. 5 in job log attribute information 702, 3 is added to the score. Thus, the score of job log data 703 is calculated as 21.4.

Accordingly, in a case where a filtering threshold (a threshold to determine whether or not the information list needs to be created) is set to a score of 25 or more, job log data 703 is hit when filtering execution date is Dec. 1, 2006, and is not hit when filtering execution date is Jun. 1, 2007.

### (Specific Example of Information List)

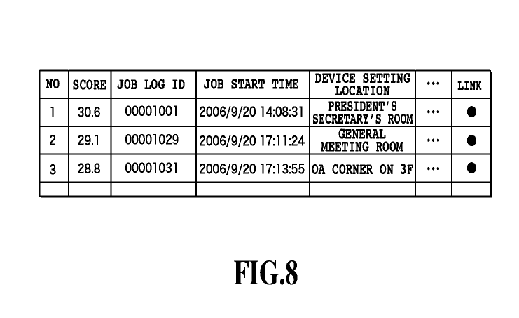

FIG. 8 shows an example of an information list of job log data created as a result of filtering processing.

The information list shows a list of job log data exceeding a predetermined threshold as a result of score calculation, as being a filtering result. In the example in FIG. 8, job log attribute information such as a job log ID, started time of a job and the like are added to the information list in addition to the score of each job log data. Moreover, the setting of link information (Link) of job log content data makes it possible to refer to desired job log data from the information list on the basis of the information.

### (Other Embodiment)

Moreover, the object of the present invention may also be achieved in such a way that a computer (or CPU or MPU) of the system or apparatus reads out and executes a program code from a storage medium in which the program code is stored to realize the procedures of the flowcharts shown in the aforementioned embodiment. In this case, the functions of the aforementioned embodiment are achieved by the program code read out from the storage medium. Therefore, the program code and a computer-readable storage medium that records or stores the program code also constitutes the present invention.

As the storage medium for supplying the program code, there may be used, for example, a floppy disk, a hard disk, an optical disk, a magneto-optical disk, a CD-ROM, a CD-R, a magnetic tape, a nonvolatile memory card, a ROM, and the like.

Moreover, the way to achieve the functions of the above described embodiment is not limited to executing the program code read out by a computer. A case is also included in which an OS (Operating System) or the like working on the computer performs a part or all of actual processing on the basis of the instruction of the program code and functions of the above-described embodiment are achieved by the processing.

Furthermore, a CPU or the like provided in an expansion board inserted into a computer or an expansion unit connected to the computer performs a part or all of actual processing and functions of the above-described embodiment are achieved by the processing. In this case, the program code read out from the storage medium is once written into a memory provided on the expansion board or the expansion unit and processing is executed by the CPU or the like on the basis of instructions of the program code.

This application claims the benefit of Japanese Patent Application No. 2007-288740, filed Nov. 6, 2007, which is hereby incorporated by reference herein in its entirety.

What is claimed is:

1. An information processing apparatus that searches for log data, comprising:
a search condition setting unit configured to set one or more search conditions;
an importance setting unit configured to set an importance of each of the search condition and a valid period of the importance in association with each other;
a searching unit configured to search for log data matching the search conditions set by the search condition setting unit;
a score calculating unit configured to calculate a score of log data matching the search conditions on the basis of an execution time of the search, importance of the respective search conditions, and valid periods of the respective importance; and
an extracting unit configured to extract log data with a score calculated by the score calculating unit exceeding a predetermined threshold.

2. The information processing apparatus according to claim 1, wherein the extracting unit creates an information list from the extracted log data.

3. The information processing apparatus according to claim 1, further comprising a notifying unit configured to notify information related to the extracted log data.

4. The information processing apparatus according to claim 1, wherein the search condition is related to at least any one of an image, a keyword, and attribute information.

5. The information processing apparatus according to claim 1, wherein the log data is related to a job executed by a device.

6. An information processing method comprising:
a search condition setting step of setting one or more search conditions;
an importance setting step of setting an importance of each of the search condition and a valid period of the importance in association with each other;
a searching step of searching for log data matching the search conditions set in the search condition setting step;
a score calculating step of calculating a score of log data matching the search conditions on the basis of an execution time of the search, importance of the respective search conditions and valid periods of the respective importance; and
an extracting step of extracting log data with a score calculated in the score calculating step exceeding a predetermined threshold.

7. A computer-readable storage medium having a computer program stored therein, the computer program configured to cause a computer to execute the information processing method according to claim 6.
